(19) United States
(12) Patent Application Publication
(10) Pub. No.: US 2009/0171752 A1
(43) Pub. Date: Jul. 2, 2009

(54) Method for Predictive Routing of Incoming Transactions Within a Communication Center According to Potential Profit Analysis

(76) Inventors: Brian Galvin, Seabeck, WA (US); S. Michael Perlmutter, San Francisco, CA (US); Grigory Shenkman, San Francisco, CA (US); Herbert Willi Artur Ristock, Walnut Creek, CA (US)

Correspondence Address: CENTRAL COAST PATENT AGENCY, INC, 3 HANGAR WAY SUITE D, WATSONVILLE, CA, 95076, US

(21) Appl. No.: 11/965,958

(22) Filed: Dec. 28, 2007

(51) Int. Cl. G06Q 10/00

(52) U.S. Cl. 705/10

(57) ABSTRACT

A transaction routing method in a contact center has steps for (a) identifying an initiator of a received transaction; (b) gathering information about the initiator of the transaction; (c) determining agents available to receive and service the transaction, and gathering information about the agents; (d) using the gathered information, determining a product or promotion; (e) forming combinations among the available agents, the initiator, and the products; (f) determining potential profit contribution or probability for individual ones of the combinations formed in step (e); and (g) selecting an agent to service the transaction based on the potential profitability determined in step (f).

### BACKGROUND OF THE INVENTION

1. Field of the Invention

The present invention is in the field of network communications, and pertains more particularly to routing of transactions in contact center environments.

2. Discussion of the State of the Art

In the field of network communication, there have been many improvements in technology over the years that have contributed to more efficient use of both voice (telephony) and text-based (email, instant messaging and the like) communication within hosted contact-center environments. Most of these improvements involve computer hardware and software adapted for, among other things, better routing of communication transactions, faster delivery of transactions and associated information, and improved service with regard to client satisfaction. Such computer-enhanced functionality is often termed in the art as computer-telephony integration (CTI), but is lately applicable to much more than just voice-based communication.

Generally speaking, CTI systems of various design and purpose are implemented both within individual contact centers and, in some cases, at the network level, such as in the Internet or a publically-switched telephony network (PSTN). For example, processors running CTI software may be linked to telephone switches, service control points (SCP), digital network telephony servers and network entry points within a public or private network. At the call-center level, CTI-enhanced processors, data servers, transaction servers, and the like, may be linked to telephone switches and servers, and in some cases, to similar CTI hardware at the network level, often by a dedicated digital link. CTI and other hardware within a contact-center is sometimes referred to as customer premises equipment (CPE). It is the CTI processor and application software in such centers that typically provides computer enhancement to a contact center.

In a CTI-enhanced contact center, telephones at agent stations may be connected to a central telephony switching apparatus, such as an automatic call distributor (ACD) switch or a private branch exchange (PBX). The agent stations may also be equipped with computer terminals such as personal computers with video display unit's (PC/VDU's) so that agents manning such stations may have access to stored data as well as being linked to incoming callers by telephone equipment. Such stations may be interconnected through the PC/VDUs by a local area network (LAN). One or more data or transaction servers may also be connected to the LAN that interconnects agent stations. The LAN is, in turn, connected to the CTI processor, which is connected to the call switching apparatus of the call center. Further, there may be servers for handling such as Internet-Protocol Network telephony, and for text-based transactions. In many cases multiple functionality may be provided in a single server or other piece of equipment

When a transaction arrives at a contact center, whether or not the transaction has been pre-processed, typically at least the initiating address, such as the telephone number of a calling party, or an IP address is made available to the receiving equipment at the contact center by a network provider. This service is available from most telephone networks as caller-ID information in one of several formats. If the contact center is computer-enhanced (CTI) the initiating address of the contacting party may be used as a key to access additional information from a customer information system (CIS) database at a server on the LAN that connects the agent workstations. In this manner information pertinent to a transaction may be provided to an agent.

In recent years, advances in computer technology, transaction switching and routing equipment and infrastructure have provided many opportunities for improving transaction service in contact centers. Similarly, development of the well-known Internet network, together with advances in computer hardware and software have led to a new multimedia telephone system known in the art by several names. In this new systemology, telephone calls are simulated by multimedia computer equipment, and data, such as audio data, is transmitted over data networks as data packets. In this application the broad term used to describe such computer-simulated telephony is Data Network Telephony (DTN).

Routing of incoming transactions within a contact center may adhere to many different rules imposed by an enterprise company hosting such a center. Routing rules may be quite complex. For example, statistical-based and skill-based routing conventions (known to the inventor) are now possible and are implemented in some current art communication centers. Predictive, priority, and real-time availability routing conventions (known to the inventor) may also be practiced.

More traditionally, routing within contact centers is based upon one, several or a combination of the above-mentioned rules. A basic focus has centered around matching the right agent to the customer making the call or transaction request. For example, if the customer speaks Spanish and is interested in obtaining information about a certain type of computer, then a Spanish speaking agent specializing in that type of computer is desired to deal with the customer.

History-based predictive routing (known to the inventor) has been implemented in some contact centers with measured success. In a history-based routing system customer information along with past history regarding purchases, credit, preferences, satisfaction level at last contact, and the like are used to predict the type of product or service for the customer and the agent that might best be able to service that customer. For example, it may be known through past purchase history that a certain customer buys a computer every two years on the average. His credit is still good with the company and he prefers a Pentium computer based on past purchase activity. It has been 22 months since his last purchase, and he was discontented somewhat during the last contact which was a service call shortly after that last purchase. Using this information, the system predicts that an agent specializing in servicing and selling Pentiums, with considerable conflict resolution skill would best handle that call. The customer may be queued for that agent even if an agent of similar but different skill set is available.

The above-mentioned example reflects just one of many possible situations wherein what is already known about a customer may aid in routing his or her transaction request. Customer satisfaction is an important goal in this instance with the possibility that the customer will buy another Pentium, of course, taken into account. This system works well in sales/service oriented situations wherein providing good service promotes future business activity. Computer sales, Appliance sales, Catalog-order sales, etc. make up this category. Service is expected from these types of companies, and is often provided equally well to frequent or high-dollar customers and to infrequent or low-dollar customers. In many cases money, which is related to profit margin, may be lost because servicing a discontented customer can, depending on circumstance, cost as much or more than an amount spent by that customer patronizing the business.

Many types of enterprises are much more profit-oriented than traditional sales/service organizations. Investment companies, Loan companies, Collection agencies, among others, fit into this category. It is desired by owners and administrators of such enterprises that a high profit margin be maintained as an important priority. Such bottom-line profit contribution may, in many cases, determine the immediate success or failure of such a company.

In addition to the above, in most contact centers the primary goal of routing is to minimize wait time for clients and customers, although to many clients and customers this may appear to be far from the actuality. Also each call is considered as an island in a sea of calls, and services and routed without regard to other calls, except in a sense of agent loading and availability.

In view of the above what is clearly needed is a method for routing of incoming transaction requests within a communication center based on knowledge of customers, knowledge of products, knowledge of agents, and prediction based on interdependency and effects of possible pairing of customer/product/agent over a variable period of time.

### SUMMARY OF THE INVENTION

The inventors in the present patent application have determined that there are better ways of routing transactions in a call center than those used in the current art, and that routing may best be performed by taking into account expected profitability to be enjoyed by an enterprise hosing a contact center. The inventors have developed a number of ways of accomplishing this purpose, and accordingly, in an embodiment of the present invention a transaction routing method in a contact center is provided, comprising steps of (a) identifying an initiator of a received transaction; (b) gathering information about the initiator of the transaction; (c) determining agents available to receive and service the transaction, and gathering information about the agents; (d) using the gathered information, determining a product or promotion; (e) forming combinations among the available agents, the initiator, and the products; (f) determining potential profit contribution or probability for individual ones of the combinations formed in step (e); and (g) selecting an agent to service the transaction based on the potential profitability determined in step (f).

In another aspect of the invention a transaction routing system in a contact center is provided, comprising a router and a data repository storing information about agents, customers and products. In this system the router identifies an initiator of a received transaction, gathers information about the initiator of the transaction, determines agents available to receive and service the transaction, and gathers information about the agents, uses the gathered information to determine a product or promotion, forms combinations among the available agents, the initiator, and the products, determines potential profit contribution or probability for individual ones of the combinations formed, and selects an agent to service the transaction based on the potential profitability determined.

### BRIEF DESCRIPTION OF THE DRAWING FIGURES

FIG. 1 is a system diagram of a telecommunication network and multimedia communication center according to art known to the inventor but not necessarily public.

FIG. 2 is a system diagram of the telecommunication network and multimedia communication center of FIG. 1 enhanced with predictive history-based routing according to an embodiment of the present invention.

FIG. 3 is a process flowchart illustrating various process steps according to an embodiment of the present invention.

FIG. 4 is a process flowchart illustrating steps in another embodiment of the invention.

### DESCRIPTION OF THE PREFERRED EMBODIMENTS

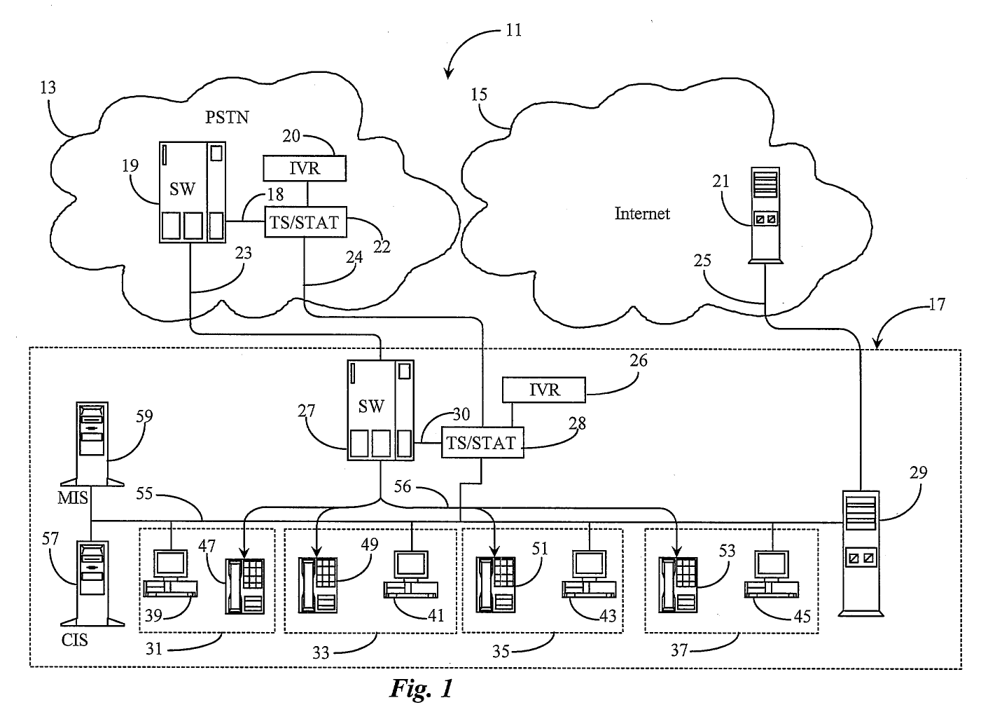

FIG. 1 is a system diagram of a telecommunication network and multimedia communication-center according to art known to the inventor, but not necessarily public, as a basis for describing the present invention.

In FIG. 1 telecommunications network 11 comprises a publicly-switched telephone network (PSTN) 13, the Internet network 15, and a multimedia communication-center 17. PSTN network 13 may be a private network rather than a public network, and Internet 15 may be another public or a private data network as are known in the art.

In this example, communication center 17 is equipped to handle both COST calls and IPNT calls which represents state of the art development for such communication centers. Both COST calls and IPNT calls are delivered to communication center 17 by separate network connections. For example, a telephony switch 19 in the PSTN may receive incoming telephone calls and rout them over a COST network connection 23 to a central switching apparatus 27 located within communication center 17. IPNT calls via Internet 15 are routed via a data router 21 over a data-network connection 25 to an IPNT router 29 within communication center 17.

In this example, an enhancement known to the inventor is provided in that network switch 19 is connected via CTI link 18 to a CTI-processor 22 running an instance of a CTI application known to the inventor as a T-server (TS) and an instance of Statistical server (STAT). An intelligent peripheral of the form of an interactive voice recognition unit (IVR) 20 is connected to processor 22 via a data link. Similar equipment is found in multimedia communication-center 17 namely, a processor 28 running instances of T-Server and STAT-server connected to central-switching apparatus 27 and further connected to a LAN 55, and an intelligent peripheral of the form of an IVR 26 which is connected to processor 28 via a data link.

Both of the above described equipment groupings are connected to each other via a separate data network 24. In this way, data about a customer may arrive at communication center 17 ahead of an actual call. This enhancement is known to the inventor and the enabled method is termed “double dipping” by the inventor. It is shown here only for the purpose of illustrating this enhancement as being available in systems as known to the inventor.

Data router 21 in cloud 15 is exemplary of routers, servers, IP switches, and other such dedicated equipment that may be assumed to be present but not specifically illustrated therein. There also may be, in network 15, processors running instances of T-servers and Stat-servers and connected to data routers, such as data router 21, and by data links to processor 28 in our exemplary telecommunication center 17, although not shown.

Call center 17 in this example comprises four agent stations 31, 33, 35, and 37 adapted to engage in multimedia interaction with customers. Each of these agent stations, such as agent station 31, for example, comprises an agent's telephone 47 for COST telephone communication and an agent's PC/VDU 39 for IPNT communication and additional data processing and viewing. Agent's telephones 49, 51, and 53 along with agent's PC/VDU 41, 43, and 45 are in similar arrangement in agent stations 33, 35, and 37 respectively. Agent's telephones, such as agent's telephone 49, are connected to COST switching apparatus 27 via telephone wiring 56.

LAN 55 connects agent's PC/VDU's to one another and to IPNT data-router 29. A client-information-system (CIS) server 57 is connected to LAN 55 and provides additional stored information about callers, usually customers of the center's host, to each LAN-connected agent. Information such as purchase history, credit information, contact information and the like is stored and retrievable. A multimedia server (MIS) 59 is connected to LAN 55 and adapted to store and serve multimedia transactions such as e-mail, video mails, IVR recordings, transferred files, etc.

Router 29 routes incoming IPNT calls to agent's PC/VDU's that are LAN connected as previously described. Data-network connection 25 connects data router 29 to data router 21 located in Internet 15. Specific Internet access and connectivity is not shown, but is well known in the art, and may be accomplished in any one of several ways. Dial-up connection and continuous LAN connection are exemplary methods.

In this example, each agent's PC/VDU, such as PC/VDU 45, has a continuous connection via LAN 55 and data network connection 25 to Internet 15 while the assigned agent is logged on to the system, however, this is not specifically required but rather preferred, so that incoming IPNT calls may be routed efficiently

In examples provides herein, an object of the description is to show a new and innovative method of routing transaction requests to resources. Agents at agent stations are good examples, but not limiting examples, of resources to which transaction requests, such as incoming calls, may be routed. It will be apparent to the skilled artisan, however, that there may be other resources to which a transaction request may be routed. As an extreme example, the system may decide by the methods of the invention, that incoming calls should go directly to an officer of the company that hosts the call center, who is on vacation, and an outbound call will be made to the officer at an alternate number available. In other instances, there may be facility at the call center to host home agents, and to provide such agents with all of the services of the call center. Although these home agent facilities are not shown in the drawings, the inventor intends that such are to be included in the methods of the invention. The system of the invention routes transaction requests to whatever resources are available and configured into the system.

Returning now to FIG. 1, an agent operating at an agent station such as agent station 33 may have COST calls arriving on agent's telephone 49 while IPNT calls are arriving on agent's PC/VDU 41.

Routing of COST events within center 17 is performed via routines associated with the T-Server running on processor 28. Routing of DNT events including IPNT calls is performed via IPNT router 29. In some embodiments, DNT routing may also be affected via processor 28 by virtue of it's T-Server capability and LAN connection.

It will be apparent to one with skill in the art that various routing protocols may be practiced within this system both at the network level and within center 17, and that predictive routing based on customer history may be practiced with system access of CIS 57 which contains information regarding the customer as previously described. However, current art regimens are somewhat limited in scope regarding updating, reporting, and access of data including cross-referencing, analyzing and so on.

While predictive routing based on history has merits within certain situations, it is desired in many instances to provide a more direct and complete analysis of a potential transaction's fiscal impact on a company whether positive or negative. This is especially true within certain profit-driven organizations as was mentioned in the background section. Therefore, it is an object of the present invention to provide a system of data storage and an intelligent routing routine, not previously available to the public, that can effectively prioritize and route calls based on an analysis of the margin of profit contribution to the company expected from a potential transaction, on a transaction-by-transaction basis.

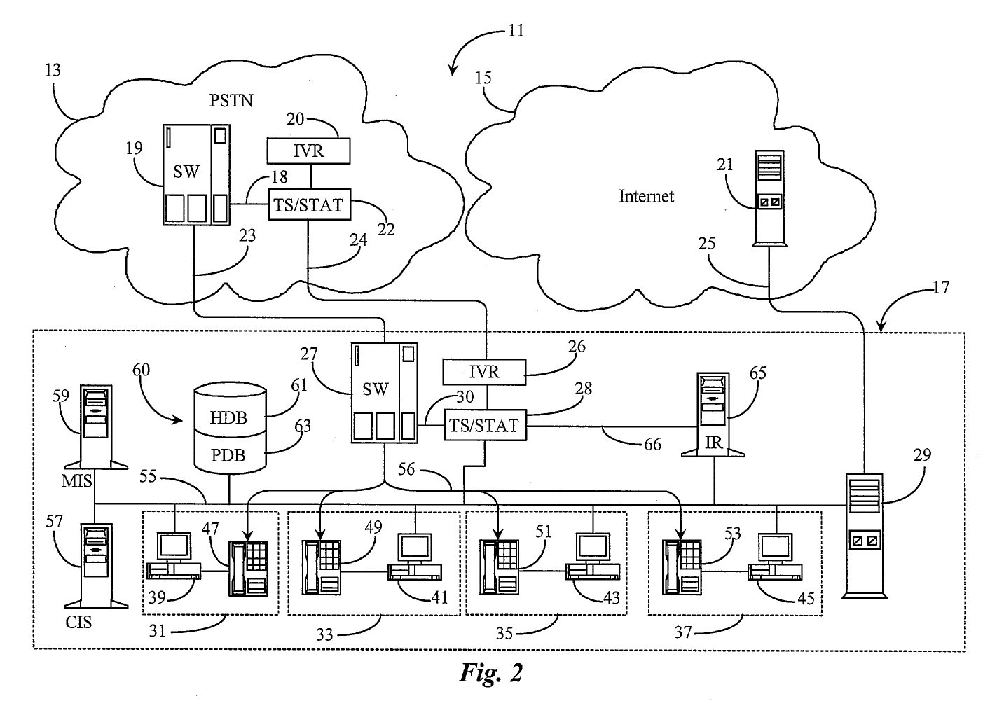

FIG. 2 is a system diagram of the telecommunication network and multimedia communication center of FIG. 1 enhanced with predictive potential-profit-based routing according to an embodiment of the present invention. In an effort to avoid redundancy, elements introduced and described with reference to FIG. 1 that are also present in FIG. 2 are not re-introduced unless they have been altered according to an embodiment of the present invention.

One basic enhancement to communication center 17 as known to the inventor involves connecting agent telephones 47-53 to their associated PC/VDU's 39-45 at agent stations 31-37 respectively, and as illustrated with the addition of connecting lines at each station. This method employs use of I/O cables to facilitate a connection from a telephone transceiver/receiver to the sound card on a computer. In this way a single headset or handset telephone may be used to receive both COST calls from PSTN 13 or IPNT calls from Internet 15. While this architecture is not required to practice the present invention, such connections aid in functional performance and call-monitoring ability within communication center 17 and may, in some instances, aid the function of the present invention.

According to a preferred embodiment of the present invention, a mass-storage repository 60 comprising a historical database (HDB) 61 and a product database (PDB) 63 is provided and connected to LAN 55. HDB 61 contains complete historical records of client status and transaction activity regarding interaction with communication center 17 such as purchase history including dollar amounts for each transaction, type of product or service purchased, date of purchase, quantity parameters, order numbers, etc. The specific character of the stored data may vary widely. It may also reside in other facilities, and be remotely accessed, by a multitenant call-center, having such a DB connection for each of the tenants sharing use of the call center. It is clear that there are many setups and configurations that can be used to achieve the same in this or other environment, but they all essentially allow access to a data base, so for simplicity purposes only one DB is shown.

Status records indicate, among other things, financial status, demographic category, family status including listings of relatives, employment record, net-worth information, and any other parameters that may be legally obtained and documented. Such information is recorded and updated over time during normal transaction occurrences between center 17 and the client. Other facts about clients may be solicited through IVR, questionnaire, purchased information from other sources, and so on.

PDB 63 contains product information such as description, pricing, promotional information, order numbers, etc. PDB 63, in this example, resides at the same location (machine 60) as HDB 61 however, a number of other possibilities exist without departing from the spirit and scope of the present invention. For example, each database may be implemented in separate LAN-connected machines within communication center 17.

In one embodiment, such data resources may be stored outside of communication center 17 such as at a central location connected via private wide area network (WAN) to, and shared by, a plurality of geographically distributed communication-centers. In an alternate embodiment, such resources may be securely hosted in public domain within network 15, which in this example, is the Internet. Data access to repository 60 may be provided via LAN 55, as taught herein, or via a WAN as explained above. There are many variant possibilities.

Information-storage rules dictate how client and product related data are stored and accessed. These rules will vary somewhat depending upon the type of enterprise (company hosting the communication center) and location of repository 60 (centralized and shared on WAN; or local on LAN). For example, clients or customers may be categorized according to demographic rules with their parameters and other known information stored in segmented fashion reflecting a particular demographic segment with higher call priority associated with one or more segments.

Accessing certain customer data from HDB 61 may be generally prohibited except via automated routine during routing of calls. In this way, certain privacy or legal aspects may be protected if applicable. Security methods such as encoding, password protection, encryption, use of firewall, and the like may be used to protect information from unauthorized agents (in case of manual access) and or the general public (if repository 60 is WAN-based). Such data protection methods are well known in the art and available to the inventor.

In a preferred embodiment, access to HDB 61 and PDB 63 occurs during automated routing of incoming calls from clients as part of a definitive and innovative process for determining the priority of, and best fit resource destination for, each incoming call based on a system analysis of real and potential profit contribution available to the company from each individual client transaction, in particular a transaction reasonably predictable from a client transaction request and access to the databases and other information with unique code routines according to embodiments of the present invention.

An intelligent router (IR) 65 is provided for the purpose of routing calls from both the COST network 13 and Internet 15 according to predictive history-based and demographics-based profit rules as briefly described above. IR 65 is connected to LAN 55 and also linked to processor 28 via data link 66. Data link 66 is not specifically required here as both IR 65 and processor 28 are LAN connected. However, performance enhancement is often achieved through direct data-linking techniques as is known in the art.

IR 65, by virtue of the innovative predictive-routing method of the present invention, is adapted to access repository 60, obtain relevant information from HDB 61 and PDB 63 that has been prepared and organized in many instances via data mining, and analyze the information in order to determine a resource destination, and in some cases a priority for each call, and then route the call based upon that determination.

In addition to the ability to search and retrieve relevant data from repository 60, IR 65 may also utilize IVR and CIS information to aid in effecting the goal as taught by the present invention. For example, if a client is new, and no current information is available about him or her in repository 60, then a new history may begin with IVR interaction at first contact such as from IVR 20 and, perhaps, from basic information which may be stored in CIS 57 which may contain, but is not limited to, contact information about potential customers or clients that have not yet patronized the company. Thus, after identifying a client, IVR 20 may obtain initial information from the caller for use in searching CIS 57 for additional information which may then be entered into HDB 61.

In addition to historical data, product data, client status, and the like, there are in some cases real time considerations to be made in determining potential profitability. For example, depending on the nature of the enterprise hosting a call center and the products and/or services offered, the IR may access periodically or continually updated records of information such as lending rates (interest rates), stock quotations, load conditions in a network, and so on, as input in various formulas and algorithms developed for determining potential profit. It should also be clear that cost issues also effect profitability and will be taken into account in many algorithms for determining potential profitability. The present invention is in the nature of the determination rather than in the specific details of how profitability might be determined. That is, it will be clear to the skilled artisan that there are a wide variety of specific algorithms that might be developed within the spirit and scope of the present invention in order to determine potential profitability, depending on such issues as the nature of products and services, the nature of the enterprise, and many other factors.

Once a call is received at central switch 27, IVR 26 may solicit further, more detailed information from the caller, perhaps taking financial information, product interests, or other qualifying demographic information which may be entered into HDB 61. IR 65 may route the call to an agent if enough data can be compiled to formulate a profit-contribution prediction.

If not enough information is known about a client, IR 65 may route the caller to an automated attendant such as an automated fax or alternative IVR attendant. Perhaps a lower priority routing to an information agent may be the determination. Any interaction results are subsequently added to HDB 61 as part of the contact history of that client. In any event, a complete transaction history including any agent/client interaction result is developed, stored and maintained in HDB 61 as the client continues to do business with the company. Interactions, as defined herein, include all multimedia transactions in addition to COST and IPNT calls that may be supported by the system including but not limited to e-mail, video mail, faxes, voice mail, WEB-initiated transaction requests, and so on.

In one embodiment, client data stored in HDB 61 is cross-referenced to product information stored in PDB 63 in order to, for example, match a relevant product promotion to a client based on purchase history. Upon selecting the correct product promotion, product scripting may be provided to an agent ahead of or with the call for use in guiding the client toward placing an order.

It will be apparent to one with skill in the art that as a client develops an interaction history with the company, an average profit contribution from the client to the company per transaction may be easily calculated on an ongoing basis from known cost values such as cost of agent time, service costs, product material costs, and so on. The results of such calculation may, of course, change over time as new variables are added and old variables are discarded. For example, a new income bracket for a client may be a new variable where as the old income information would be purged from HDB 61, and so on. Other methods may also be used rather than just average. For example based on the last transaction being ATM card “eaten” by ATM machine, it is quite reasonable to assume the following transaction is a complaint about that rather than new business, and hence the call may be bumped off to an IVR or a low priority queue. So from this example, it is clear that event sequences can be used to determine the “net value” of the next transaction. Other factors could be time of day (at customer and/or business location, his current location vs. his “normal location”, time of month, time of year, whether at his present location etc.

It will also be apparent to one with skill in the art that the software containing the routine of the present invention may reside in processor 28, IR 65, repository 60, or a combination thereof. Instances of such a routine may also reside at individual agent PC/VDU's such as PC/VDU 39.

It will likewise be apparent to one with skill in the art that underlying rules for determining real and potential profit contribution from a client may vary considerably with call priority determination based on a relatively few or a large number of stored variables. A more detailed example of possible steps performed by the software of the present invention in determining profit contribution and best-fit destination is provided below.

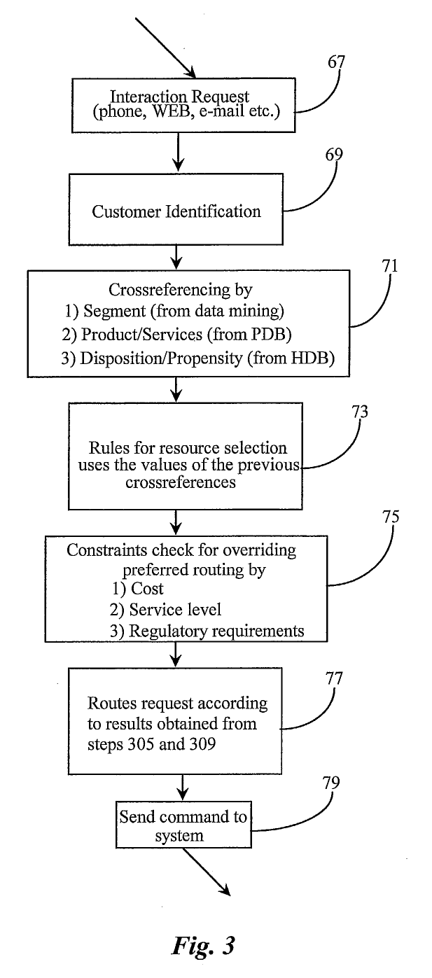

FIG. 3 is a process flowchart illustrating various process steps according to an embodiment of the present invention. The basic steps in determining potential profit contribution, assigning priority and routing an incoming transaction request according to an embodiment of the present invention may vary considerably depending on, among other factors, type of enterprise, products or services offered, number of variables considered, and so on. FIG. 3 is intended to reflect just one example of a possible process sequence.

In step 67, an interaction request is registered at either switch 27 or IPNT router 29 of FIG. 2. An interaction request is defined as being of the form of any supported media such as e-mail, COST call, IPNT call, WEB request, video mail, etc. In step 69, the customer is identified through any one or by a combination of known methods such as caller line identity, domain-name ID, return e-mail address, IP address, and so on. In step 71, data regarding the customer is accessed from HDB 61. IVR 26 and CIS 57 may also contribute to the data pool.

Certain variables such as demographic category, from such info as last credit report, average profit contribution and so on is performed along with cross-referencing to PDB 63 for appropriate product/service information including information on current product promotions, quantity discounts, current interest structure for finance, and so on. Customer disposition at last contact along with propensity toward a purchase decision as averaged over past transaction history may also be obtained from HDB 61.

The retrieved data and cross referencing performed in step 71 will produce the integral variables usable by the routing routine to determine a priority and a resource destination for the transaction request in terms of probable profit contribution, and to make an appropriate resource selection in step 73. A bottom-line predicted profit contribution for the existing transaction is calculated from analyzing of the data. In step 74, a constraint check is performed to validate the interaction and associated data against any preset override conditions set up by the enterprise, such as legal requirements, service level, or cost restraints as well as customer rating which may alter or override prior routing strategy.

In step 77, the routing routine routes the interaction request according to results obtained in steps 71, 73, and 75. If it was calculated that a high profit contribution is probable, then priority for the interaction is high and the interaction is handled accordingly. If however, it is determined that the probable profit contribution is low, non-existent, or even a drain on the company, a lower priority disposition of the caller is warranted. In step 79, the actual command to route the interaction to a selected destination is given to the appropriate delivery system apparatus such as IPNT router 29, switch 27, MIS 59, etc.

In one embodiment wherein a repository such as repository 60 is shared by a plurality of communication centers, existing routines using the same information may vary in process and priority determination methods according to local rules set up at each separate communication center.

Regular updating to repository 60 may be performed via a variety of ways without departing from the spirit and scope of the present invention. For example, manual updating may be part of the duties of a system administrator. Results from mailed questionnaires, automated customer surveys, communication center transactions, purchased information from other sources, credit reporting agencies, demographic studies, and so on, may be entered to and made part of HDB 61. Continual updating and purging of non-valid information is pertinent to maintaining system integrity.

In the methodology described so far above, voice transactions are emphasized. The networks, however, are capable of text-based transactions as well, and in the teaching that follows transactions of all sorts are intended to be considered and treated. Further, terminology above refers in many cases to call centers and communication canters, and below reference is often made to contact centers, all of which may be related and partial or sub-sets of one another. The inventions taught and claimed below are meant to apply to all sorts of transactions, both voice and text, that may be encountered in contact center technology.

In the methodology described so far above, focus is on a sequential approach to profit-based routing. Referring now to FIG. 3, for example, the customer is identified, then the likely profitability of this particular transaction (and just this particular transaction) is calculated using customer history information and product information. Then a priority for routing the interaction is determined based on results of the profitability analysis, and a resource destination is selected and sent to the router. Also, in the description thus far it is the history of the customer in previous interactions with the contact center itself that is considered for profitability analysis.

In another aspect of this invention, optimization of profitability can be done in a much more powerful way by considering, for each interaction, some or all of customer, product/campaign, agent mixes that might be used to service this call. It is really the three together—customer, product, agent—that determines the likelihood of making a profitable sale. And it should be clear that for a given customer, there might be a quite large number of possible product/agent pairs that could be assembled (a product/agent pair, say [p1,a1], means the customer is routed to agent a1 and that the agent is prompted to offer product p1). One of these assignments likely can be predicted the most profitable of all of the possible combinations. What is more, it is most desirable to optimize total profit across all interactions, which means in some cases it may be preferable to take a less than optimal pairing in one customer's case because it allows the system to choose a much higher profit pairing in another case. The optimal solution is a multidimensional optimization problem.

Solving this optimization problem predictively as part of the routing problem, and then routing the interaction and giving product-related sales prompts in accordance with the selected agent/product pairing should deliver the highest overall profit for the enterprise. The description relative to FIGS. 1-3 above only really considers taking each transaction in isolation and calculating expected profitability based solely on customer data extended by, for instance, looking for product promotions that correlate with the customer's known product preferences; it does not seek to address the total profit across all calls.

The customer part of this triplet is clear—it is the customer who is initiating a transaction, or who may be called in an outbound campaign. But in considering who this customer really is, in one embodiment it is important to look not just to the customer's previous history in the contact center, but all available history with the enterprise for that customer. Particularly, recent web site visits are often very revealing and may indicate a level of interest in a particular product or category. Furthermore, analysis of web site activities may show inclination to buy. For instance, if a customer has an active shopping cart in a web site associated with the enterprise, and left without buying, and has then initiated a contact with the contact center, an examination of the contents of the cart might indicate promising selections for upsell/cross-sell offers in the contact center. In addition to demographic clues, psychographic data can be used as well to provide insight into likelihood of the customer's being responsive to a sales offer in the contact center. For example, if previous history indicates a strong preference for buying in person at a retail outlet, especially after previewing products online, one might choose to offer the client a coupon for the target products while the customer is on the phone, and then to refer the client to the local store. One could even offer to set up an appointment with a store clerk (who would have access to the coupon electronically so the customer does not have to print anything out or receive anything in the mail. Of course, customer product preferences are important and should be part of the mix.

The product part of the triplet relates clearly to products available for sale in the contact center. In fact, it may often be better to think in terms of campaigns, in which particular products are desired to be promoted to particular customer segments, with inducements such as sale prices or special offers on related products, and for particular periods of time.

The agent element of the triplet is where significant novelty over prior art systems appears. As with customers, psychographic and demographic factors for agents are crucially important. Agents are people, just as customers are, and thinking of them as more fully actualized individuals, rather than simply as collections of predefined skills (as is standard in the art) can dramatically improve profitability of a contact center. Attributes that might seem “off limits” such as race, sex, age, education level, regional dialect, aggressiveness, calming effect on customers, and so forth are all relevant if they may affect potential profit. For example: if a Latino man calls in to a banking contact center and is served by a woman from the south of Boston, he might very well have less propensity to apply for an unsolicited loan than he would if we were speaking to a Latino male like himself. Or a highly educated customer considering travel options might respond better to an educated, older woman than a young man still in college. These are not matters for prejudicial consideration, but matters for quantitative analysis. The more information one has at hand in one's historical databases about previous interactions between agents and customers, and the more “dimensions” one can examine, the more likely it is that strongly correlated effects might appear. Similarly, it is quite common for agents to gravitate toward selling certain products over other products. On the simplistic assumption that people sell better when they are selling something they like to sell, the knowing which products are in the “sweet spot” for each agent is possible.

It is important to highlight that the present disclosure is not describing “skills-based routing” as previously known in the art here. The inventors are instead describing analyzing each agent and each customer, across a number of relevant predictive dimensions, to understand how the behavior of each varies with different combinations of customer types and agent types. These calculations can take advantage of near-real-time data as well, for instance making adjustments automatically when it turns out that a particular marketing campaign tends to produce better results with certain demographics, especially when they are paired with agents of the same demographic. Skills-based routing systems in the art cannot accomplish this sort of adaptivity because “skills” generally reflect either administrative relationships (you are assigned to supervisor A and have taken training course B, therefore you have skill C), or desired traffic management decisions (we are getting hit on sales-call answer times, so let's add the Sales skill to these ten agents to augment the group for the next hour). Skills used in “skills-based routing” are not sophisticated estimates of likely outcomes under current conditions, or even measured aptitude in certain work types.

Bringing these threads together, when one has available, at the time of making a routing decision, a large body of information about a customer, including information from other-than-contact-center sources (and possibly including projecting the historical results from other similarly situated customers to get a better statistical sampling), and all of the information about all the campaigns in effect, and the same level of detail about each agent, something altogether new is possible. It is possible then to calculate, for each possible customer/product/agent triplet (some mathematically possible combinations can be excluded because the agent is not qualified to sell, or the customer is not eligible to buy, the given product), the expected profit to be obtained from an interaction, possibly including downstream effects, such as likely store visits that result in sales as result of offer made on the phone). So for each customer, a relatively large number of profit estimates can be made. Additionally, it is possible to calculate second-order profit contributions, in which product A may be sold at a certain profit, and then one or more additional products can be predicted to be bought with a certain likelihood (people who buy shoes on the phone are likely to buy a second pair in a second color, for example). This result can be calculated quite quickly, and can be simplified by picking, for each customer/agent pair, the most profitable product (i.e., pick the triplet from among those having the given customer and agent that has the greatest profit potential, and then calculate second order effects for only this triplet among all those possible for this customer/agent pair). However, the speed benefit here might not be worth the effort if one reasonably expects that the first product might not be the most profitable overall. For example, in a banking scenario where various products can be offered, it might be the case that the probability of selling a home equity loan (a highly-profitable product) is much higher if one first sells some simpler product. Or, when selling fashion gear, one might have the highest probability of selling expensive items such as jewelry if one is selling them as accessories after initially selling an item of clothing. In these cases, one could devote the computational resources to calculating all customer/product/agent triplets' expected profitability including second-order effects or even third-order effects.

When this has been accomplished, one has an assembly of expected profit contributions for each customer contact, each based on assigning that contact to one of the possible agents. One could simply route each contact based on selecting, from the available agents, the one with the highest profit contribution for this customer; this would constitute a significant advance over most routing performed in the art today, and this is one embodiment of the present invention.

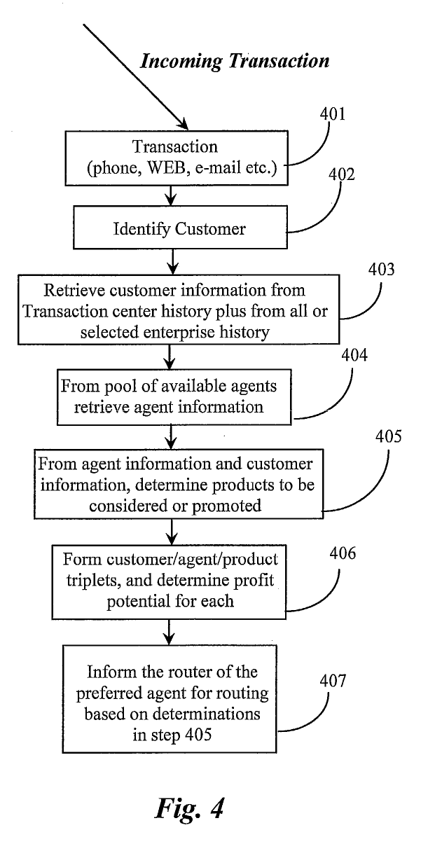

FIG. 4 is a process flow chart illustrating one embodiment of the present invention. In FIG. 4 a transaction is received at step 401 and the initiator of the transaction is identified at step 402. The identification may be a telephone number, or an IP address, or some other ID, depending largely on the nature of the transaction. At step 403 information about the initiator is retrieved from a CIS database on the LAN at the contact center, based on the ID derived in step 402. In one embodiment of the invention the information stored about the customer is not just historical information regarding the customer's interactions with the contact center, but also demographic information, income information, gender, age, and much more. In one embodiment information is also stored and retrievable concerning the customer's interactions with the enterprise in other than contact center interactions, such as customer's visits to an enterprise website, a history of payments, etc.

At step 404, from the pool of available agents to whom the transaction might be routed, agent information is retrieved for all good candidates (under some conditions some agents may be disqualified at the outset). At step 405, considering possibly agent information and customer information, a set of potential products is selected. At step 406 a plurality of agent/customer/product combinations are formed, and a potential profit contribution is predicted for each. Finally at 407 one of the combinations is selected and the determination of the available agent is sent to the router.

In a further embodiment of the invention, when there are many customer contacts to route, there will be many combinations of customers-to-agents that can be chosen. It is not necessarily true (and likely isn't true) that simply selecting the most profitable (in terms of expectation) agent for each customer while ignoring all other pending customer interactions will give the highest overall profitability, which is after all the goal. Put another way, maximizing the likely profitability of each interaction is not the same as maximizing the overall productivity of the contact center (or centers) across all of the customer interactions. This is because it is possible that giving customer A to agent B, despite the fact that agent C has a higher expected profitability when paired with customer A, may free up agent C to be assigned to customer D, who has an even higher expected profitability. In this simple example, it is possible that P(A,B)+P(C,D)>P(A,C)+P(B,D) even though P(A,C)>P(A,B), where P(X,Y) is the expected profit from assigning customer X to agent Y.

When taken across a large contact center or group of related centers, where in many cases several thousand agents may be serving customers from a wide variety of segments, the seemingly insignificant differences such as that one might find between P(A,B)+P(C,D) and P(A,C)+P(B,D) can be very large. Note that we really need to compare all of the possible combinations of agents and customers that may reasonably be made, calculating the profit expectation for each different combination and selecting that which maximizes profitability. This is a mathematical optimization problem, and there are several algorithmic approaches that are useful to solve it. But the approach is quite novel in the art of customer interaction management; it has been the practice in the art to route each interaction independently, taking into account historical statistics but not taking into account other decisions that might be made concerning other calls that are pending.

In some embodiments there may be a central repository for sharing routing over more than one contact center, to increase the number of combinations that might be considered. Also in some embodiments the combinations may be made over all agents, rather than just available agents, and after combinations are prioritized according to profit contribution, the set of available agents is considered to select the agent to whom the call should be routed.

Another important aspect of the invention in some embodiments is the use of variable time slots to determine which calls should be considered together in the overall profit calculations described above. For instance, if one wanted to consider only calls arriving simultaneously in order to compare expected profitability under different agent/customer/product pairings, two problems immediately emerge. The first is the working definition of simultaneity. The second is the small sample sizes one might have to work with. The closer one chooses to adhere to strict simultaneity, for instance by requiring the calls to arrive, for example, within 500 milliseconds of each other, the smaller the sample size would be and the less useful the result. So we will usually want to define time slots that are long enough to allow us to build up a significant sample of calls, yet short enough that someone arriving at the beginning of the time slot and not routed until the end of the time slot will not perceive any disservice as having been done. Choosing the most useful time slot length is a matter that will depend greatly on the business, its customers, and the balance of tolerable service quality risk against increasing profits by being more selective in routing. Accordingly, in an embodiment of the invention the time slot length may be set as a variable, defined a sliding window of time T during which all calls arriving will be treated as if they had arrived together, and can therefore be analyzed for maximum profitability together. The time slot length might be varied as well during operation to gauge the effects of time slot variance on profitability, and adjustments may be made as a result.

Considering this time slot variable, and referring again to FIG. 4, in one embodiment of the system a time is set, and all calls received in the time slot are grouped for a set of computations. All of the combinations for all of the calls are considered, then each call priority by profit is considered against other calls within the time slot, and tradeoffs are accomplished in the determination of routing. For example, the best agent for one call may produce a potential profit P1, while that agent in combination with another call may produce yet a bigger profit potential, and the routing is then prioritized over all of the calls in the time slot, rather than just over the combinations of agent/customer/pro duct.

Also, “arrival time” for a transaction is not a simple concept. Many calls, for example, are sent to an IVR before being routed to an agent. Selecting calls arriving simultaneously in the IVR would not do much good, since routing occurs at the end of the IVR treatment and calls stay in the IVR for varying amounts of time. What is needed is to consider calls coming out of the IVR and becoming available for routing to agents.

This may seem straightforward but in fact is anything but straightforward, because the operator of a contact center can exert considerable control over how and when calls leave the IVR. If desired, in an embodiment IVR scripts may have variable delays built in to allow rearranging of the order in which calls leave (give customer A a longer wait for the next announcement than customer B, thus moving customer B along more quickly). Also, consumers expect some amount of delay once routing begins, so there is a fair amount of leeway in terms of letting one call linger for a few seconds in order to deliver another call to the perhaps only available agent, because of profitability concerns.

It is almost always the case that callers in an IVR will be identified relatively early in a call. When this happens, the process of evaluating potential profitability of calls can begin. So essentially there is an inventory of calls “in the IVR” which can be analyzed and possibly reordered, some accelerated to catch a particularly auspicious agent pairing, and others delayed to wait for an ideal agent. The routing system is always aware of which agents are on calls, and especially if the system feeds “process progress” signals to the router to indicate how much longer calls are likely to take, then the router can in effect have a “schedule” of agent availabilities for the next several minutes, and the router may also in effect have a “schedule” of likely call arrivals based on analyzing the calls in the IVR (some of which may finish in the IVR and never need routing; if the IVR application is written to do it, it can tell the router which calls are likely to require routing, and when, and how much leeway the IVR application can provide in terms of contingent delays).

So in one embodiment the router can look at a schedule of calls that will likely arrive, knowing in advance how much it can manipulate the schedule, and a schedule of agents' becoming available (this could also be manipulated by sending signals to the agents). So now our “one off” comparison of all possible agent/customer/product triplets for a given set of callers and available agents becomes more nuanced—we have the ability to control the time dimension.

So in one embodiment of the invention the router may employ not only a time slot, but knowledge from IVR information of many calls that will shortly be available to be routed, and even prediction, based on such as average time for a call, of which agents will shortly be available, instead of just which agents are available.

One approach to leveraging modest control of the time dimension to better maximize profitability in an embodiment of the invention is to arrange for calls to arrive in tight “bunches” timed to arrive after a reasonable agent inventory is assembled. This seems counterintuitive to the mainstream in contact center thinking, wherein everything is routed as soon as possible in a manner that minimizes the total wait time of customers first, considering all other parameters such as service quality after delivery or call profitability as secondary metrics. In the quest for efficiency, often justified in terms of improving answer times (which is considered a proxy for improving quality), centers try to keep their agent utilization (defined as the percentage of paid time that agents are actively serving customers) at a maximum. Given this, it hardly seems wise to intentionally let a pool of available agents build up. But in fact, if one can, with finesse and avoiding customer dissatisfaction, arrange to have tight groups of calls arrive when there are agents available, then one can do a thorough profit optimization exercise.

Another approach in another embodiment is to use an idea that is familiar from financial markets. When calls and agents are becoming available for pairing essentially randomly, it will be rare that a statistically significant sample of either will accumulate. However, if a call is released from the IVR for routing and there is an agent available, but the system knows there is a much better caller for that agent (i.e., one whom that agent is much more likely to sell a product to), and similarly if the system knows that a suitable agent for this caller is likely to become available shortly, then the optimal path is to let this customer wait until the better agent comes along, preserving the currently available agent in the idle state until the “better qualified” customer leaves the IVR. This is similar to the use of options in financial and commodities markets. If you think of agents as commodities and callers as buyers, then it may be best to give the caller an option on a better agent, and to use an option approach for the caller still in the IVR (that is, the agent who is available gets “put” option guaranteeing that he can “sell” his service to the caller who is still in the IVR, and the caller who is waiting for an agent gets a “call” option guaranteeing that he can “buy” the service of the better-qualified agent when that agent becomes free. The value of these options might in principle be calculated using the well-known Black-Scholes option formula if desired, although it is not necessary to do so.

To summarize, the current invention provides a system for maximizing the profitability of a contact center on a global basis rather than a per-call basis by taking into account a robust variety of contributors to profitability.

It will be apparent to the person of ordinary skill in the art that there are a variety of changes that might be made in embodiments of the invention without departing from the spirit and scope of the invention. For example, the time slices that might be made and enforced in profitability routing may vary considerable. Limits might be imposed on time for calculation. a variety of pairings might be considered. There are many other variances that might be made within the spirit and scope of the invention.

What is claimed is:

1. A transaction routing method in a contact center, comprising steps of:
(a) identifying an initiator of a received transaction;
(b) gathering information about the initiator of the transaction;
(c) determining agents available to receive and service the transaction, and gathering information about the agents;
(d) using the gathered information, determining a product or promotion;
(e) forming combinations among the available agents, the initiator, and the products;
(f) determining potential profit contribution or probability for individual ones of the combinations formed in step (e); and
(g) selecting an agent to service the transaction based on the potential profitability determined in step (f).

2. The method of claim 1 wherein the information about the initiator includes historical information other than the initiator's transactions with the contact center.

3. The method of claim 1 wherein transactions include both voice-based and text-based transactions.

4. The method of claim 1 wherein identity of the initiator comprises a telephone number or an IP address, or both.

5. The method of claim 1 wherein, in step (c) information is gathered concerning agents without regard to availability to receive a transaction, and availability is considered in step (g).

6. The method of claim 5 wherein a transaction is saved for an agent not determined to be immediately available based on a high potential profit contribution, and information that the agent will likely be available shortly.

7. The method of claim 1 further comprising a step for performing steps (a) through (f) for a plurality of transactions received in close time proximity, and performing step (g) based on the potential profitability for the plurality of transactions in the multiple combinations for each call.

8. The method of claim 7 further comprising a step for setting a time slice of a specific duration and a specific start time, wherein steps (a) through (f) are performed for all transactions received during the time slice, and step (g) is performed thereafter.

9. The method of claim 7 wherein a new time slice begins when each previous time slice ends, and agent selection step (g) is made for all calls in each time slice as information gathering and determinations are made in further time slices.

10. The method of claim 1 wherein receipt of a transaction to enter the process is determined to be after an incoming voice transaction clears an interactive voice response (IVR) system and is deemed ready for routing determination.

11. The method of claim 10 wherein one or both of knowledge of calls in the IVR, and knowledge of agents to shortly become available is used populate groups of transactions upon which to perform the method steps.

12. The method of claim 7 wherein incoming transactions are saved for a period to allow groups of agents to become available to service the transactions before the method steps are performed.

13. A transaction routing system in a contact center, comprising:
a router; and
a data repository storing information about agents, customers and products;
wherein the router identifies an initiator of a received transaction, gathers information about the initiator of the transaction, determines agents available to receive and service the transaction, and gathers information about the agents, uses the gathered information to determine a product or promotion, forms combinations among the available agents, the initiator, and the products, determines potential profit contribution or probability for individual ones of the combinations formed, and selects an agent to service the transaction based on the potential profitability determined.

14. The system of claim 13 wherein the information about the initiator includes historical information other than the initiator's transactions with the contact center.

15. The system of claim 13 wherein transactions include both voice-based and text-based transactions.

16. The system of claim 13 wherein identity of the initiator comprises a telephone number or an IP address, or both.

17. The system of claim 13 wherein information is gathered concerning agents without regard to availability to receive a transaction, and availability is considered afterward as an agent is selected.

18. The system of claim 17 wherein a transaction is saved for an agent not determined to be immediately available based on a high potential profit contribution, and information that the agent will likely be available shortly.

19. The system of claim 13 further comprising a plurality of transactions received in close time proximity, and agent selection is based on the potential profitability for the plurality of transactions in the multiple combinations for each call.

20. The system of claim 19 further comprising a function for setting a time slice of a specific duration and a specific start time, wherein functions are performed up to agent selection for all transactions received during the time slice, and step agent selection is performed thereafter.

21. The system of claim 20 wherein a new time slice begins when each previous time slice ends, and agent selection is made for all calls in each time slice as information gathering and determinations are made in further time slices.

22. The system of claim 13 wherein receipt of a transaction to enter the process is determined to be after an incoming voice transaction clears an interactive voice response (IVR) system and is deemed ready for routing determination.

23. The system of claim 22 wherein one or both of knowledge of calls in the IVR, and knowledge of agents to shortly become available is used populate groups of transactions upon which to perform the method steps.

24. The system of claim 19 wherein incoming transactions are saved for a period to allow groups of agents to become available to service the transactions before the method steps are performed.
